(19) United States
(12) Patent Application Publication
(10) Pub. No.: US 2007/0091123 A1
(43) Pub. Date: Apr. 26, 2007

(54) Image managing apparatus, image managing method and storage medium

(76) Inventor: Hiroyuki Akashi, Chofu-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/586,967

(22) Filed: Oct. 25, 2006

(30) Foreign Application Priority Data
Oct. 26, 2005 (JP) 2005-311558

(51) Int. Cl. G09G 5/00

(52) U.S. Cl. 345/629

(57) ABSTRACT

An image managing method of an image managing apparatus which includes a display device and which manages a plurality of original images, the method includes displaying the plurality of images obtained by reducing the original images, indicating conditions on which display orders of the plurality of images are determined, setting the display orders of the plurality of images displayed in the display device or hidden by the displayed images in accordance with the indicated conditions, and updating the display in accordance with the set display orders, wherein the setting of the display orders of the plurality of images is to set the display orders of the plurality of images displayed based on information imparted during photographing of the images or information of display states of the images in the display device in accordance with the conditions indicated to determine the display orders of the plurality of images.

### CROSS-REFERENCE TO RELATED APPLICATIONS

This application is based upon and claims the benefit of priority from prior Japanese Patent Application No. 2005-311558, filed Oct. 26, 2005, the entire contents of which are incorporated herein by reference.

### BACKGROUND OF THE INVENTION

1. Field of the Invention

The present invention relates to an image managing apparatus, an image managing method and a storage medium in which it is possible to efficiently refer to displayed images overlapping one another in a list display screen of images displayed in free positions on the screen.

2. Description of the Related Art

When a plurality of images are displayed in a free arrangement on a screen, the images overlap one another sometimes. At this time, owing to a difference of a display size among the images, some images become completely hidden from view by the other images. Even if a part of the hidden image can be recognized, to operate this image, such an operation as to move the image displayed on the hidden image is necessary, which is laborious.

On the other hand, a technology is disclosed in which when a mouse is operated in a multi window system, a dialogue balloon, an icon or the like is generated for a hidden window (Jpn. Pat. Appln. KOKAI Publication No. 10-293673).

### BRIEF SUMMARY OF THE INVENTION

A first aspect of the present invention is directed to an image managing apparatus which includes a display device to display an image and which manages a plurality of original images, the image managing apparatus comprising: an image display unit which displays in the display device a plurality of images obtained by reducing the original images; a display order indication unit which indicates conditions to determine display orders of the plurality of images; an order setting unit which sets the display orders of the plurality of images displayed in the display device or hidden by the displayed images in accordance with the conditions indicated by the display order indication unit; and a display update unit which updates the display of the display device in accordance with the display orders set by the order setting unit, wherein the order setting unit sets the display orders of the plurality of images displayed in the display device based on information imparted during photographing of the images or information of display states of the images in the display device in accordance with the conditions indicated by the display order indication unit.

A second aspect of the present invention is directed to an image managing method of an image managing apparatus which includes a display device to display a plurality of images and which manages a plurality of original images, the method comprising: displaying in the display device the plurality of images obtained by reducing the original images; indicating conditions on which display orders of the plurality of images are determined; setting the display orders of the plurality of images displayed in the display device or hidden by the displayed images in accordance with the indicated conditions; and updating the display of the display device in accordance with the set display orders, wherein the setting of the display orders of the plurality of images is to set the display orders of the plurality of images displayed in the display device based on information imparted during photographing of the images or information of display states of the images in the display device in accordance with the conditions indicated to determine the display orders of the plurality of images.

A third aspect of the present invention is directed to a storage medium in which a program is stored, the program being executed by an image managing apparatus which includes a display device to display a plurality of images and which manages a plurality of original images, the program executing: an image display step of displaying in the display device the plurality of images obtained by reducing the original images; a display order indication step of indicating conditions on which display orders of the plurality of images are determined; an order setting step of setting the display orders of the plurality of images displayed in the display device or hidden by the displayed images in accordance with the conditions indicated in the display order indication step; and a display update step of updating the display of the display device in accordance with the display orders set in the order setting step, wherein the order setting step sets the display orders of the plurality of images displayed in the display device based on information imparted during photographing of the images or information of display states of the images in the display device in accordance with the conditions indicated in the display order indication step.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a list display screen;

FIG. 2 is a diagram showing a sort menu;

FIG. 3 is a diagram showing a list display screen;

FIG. 4 is a diagram showing a list display screen;

FIG. 5 is a diagram showing a list display screen;

FIG. 6 is a diagram showing classifications of groups;

FIG. 7 is a block diagram showing a constitution of an image managing apparatus;

FIG. 8 is a flow chart showing an image display processing procedure;

FIG. 9 is a flow chart showing an index image sort processing procedure; and

FIG. 10 is a flow chart showing a processing procedure to acquire an original image.

### DETAILED DESCRIPTION OF THE INVENTION

### First Embodiment

There will be described an outline of an image managing method in the present embodiment.

FIG. 1 is a diagram showing a list display screen 1.

In the list display screen 1, a tool menu area 2 and a data display area 3 are disposed.

In the tool menu area 2, a sort button 2a and an end button 2b are arranged. In the data display area 3, a plurality of images for indexes indicating original images can be displayed. Each index image is displayed in a size which reflects a size of the original image. In the data display area 3 shown in FIG. 1, a plurality of index images “image 1” to “image 6” and a mouse pointer 4 are displayed.

In FIG. 1, since the “image 5” is hidden by the “image 6”, a user cannot visually recognize the “image 5”.

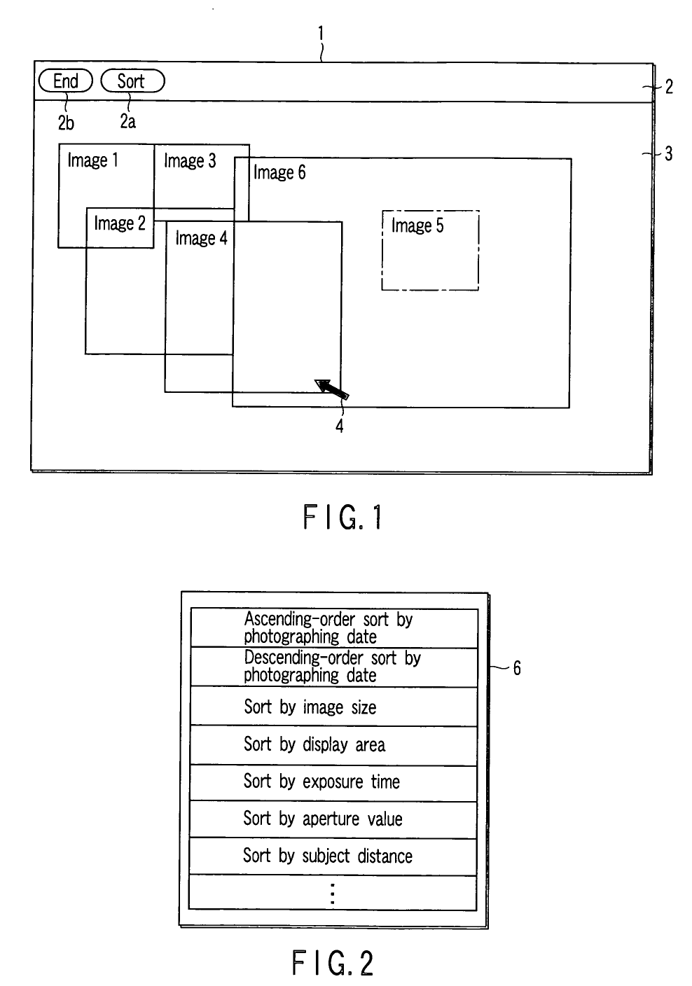

In this case, when the user clicks the sort button 2a, a sort menu 6 shown in FIG. 2 is displayed.

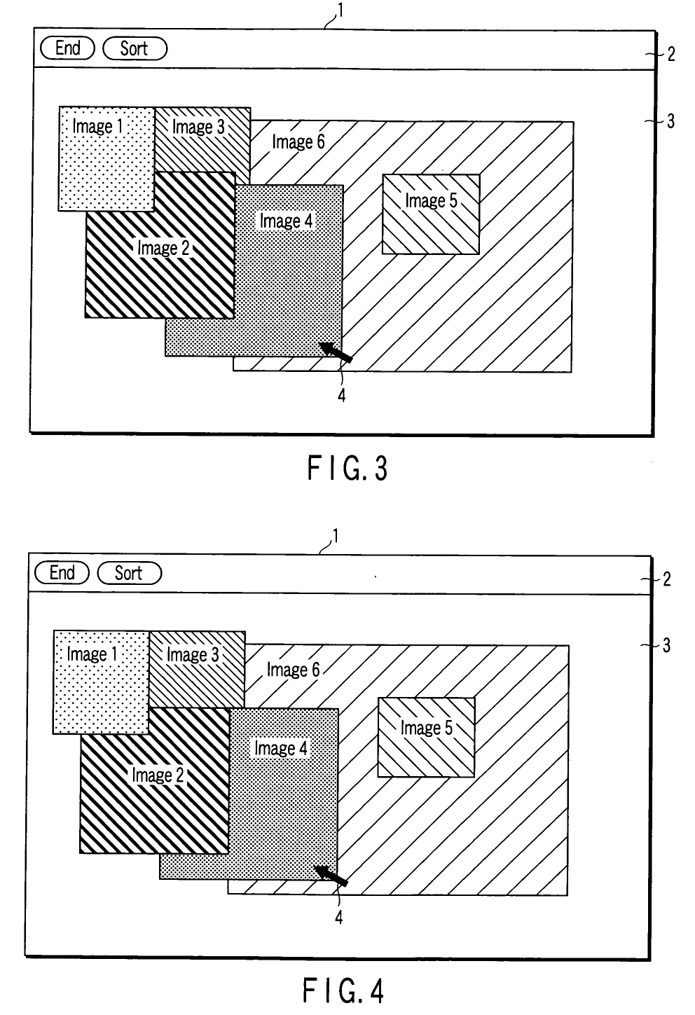

When the user selects “ascending-order sort by photographing date” or “descending-order sort by photographing date” from the sort menu 6, dates when image data have been photographed are compared with each other, and display orders of the images are changed. In consequence, as shown in FIG. 3, the list display screen 1 is updated and displayed.

As a result of the sorting, since the display order of the “image 5” is at the rear of the “image 6”, the user can visually recognize the “image 5”.

When the user selects “sort by image size (the smaller the image size is, the higher the order becomes)” from the sort menu 6, the sizes of the index images are compared with each other, and the display orders of the images are changed. In consequence, as shown in FIG. 4, the list display screen 1 is updated and displayed.

As a result of the sorting, since the display order of the “image 5” is at the rear of the “image 6”, the user can visually recognize the “image 5”.

When the user selects “sort by display area (the smaller the display area is, the higher the order becomes)” from the sort menu 6, the display areas of the image data at a time when the sort menu is selected are compared with each other, and the display orders of the images are changed. Moreover, as shown in FIG. 5, the list display screen 1 is updated and displayed.

As a result of the sorting, since the display order of the “image 5” is at the rear of the “image 6”, the user can visually recognize the “image 5”. Since the display area of the “image 4” is smaller than that of the “image 2”, the whole “image 4” is displayed.

Similarly, the user can select “sort by exposure time”, “sort by aperture value”, “sort by subject distance” or the like from the sort menu 6 to change the display order of the image data.

Moreover, the above change of the display orders can be performed for not only all the index images displayed in the data display area 3 but also the images which belong to a specific group.

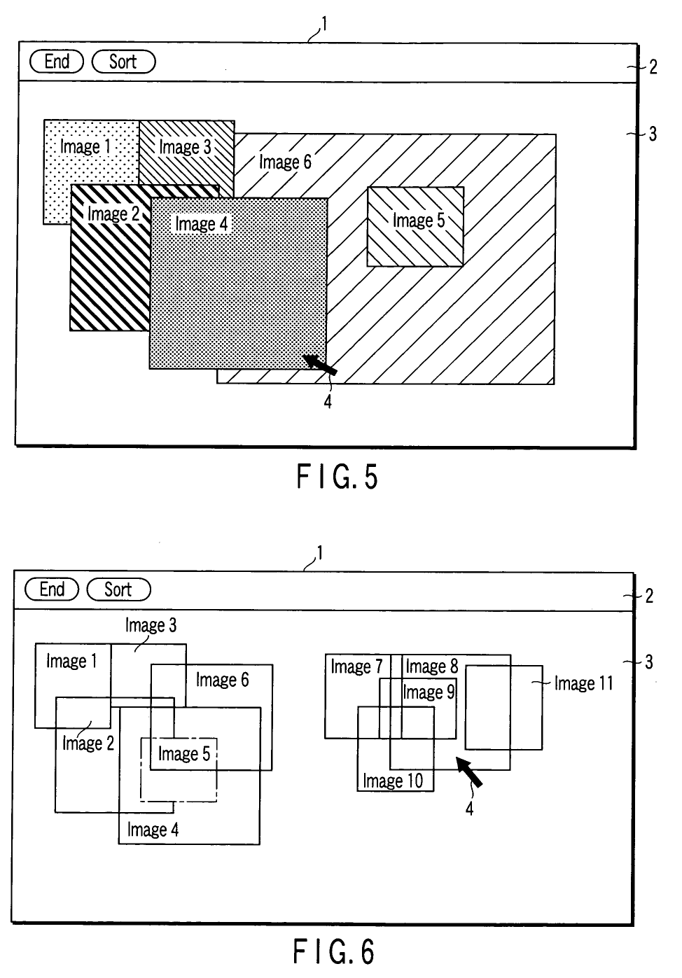

FIG. 6 is a diagram showing classifications of the groups.

A plurality of index images which overlap one another or come into contact with one another form one group. When one index image is selected with a mouse, a group including the selected index image is specified. When the user designates the above sort operation, the display orders of index images which belong to the specified group are changed.

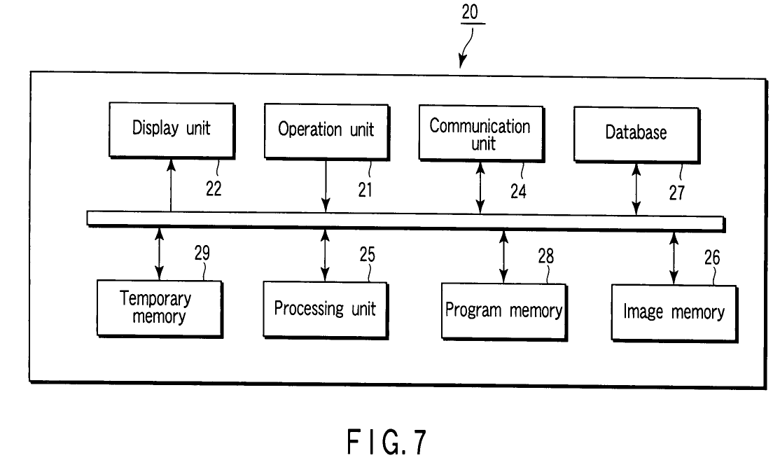

FIG. 7 is a block diagram showing a constitution of an image managing apparatus 20 for realizing the above image managing method.

The image managing apparatus 20 is provided with an operation unit 21, a display unit 22, a communication unit 24, a processing unit 25, an image memory 26, a database 27, a program memory 28 and a temporary memory 29.

The operation unit 21 includes input members such as a mouse and a keyboard for operating various functions and inputting instructions. The display unit 22 displays the list display screen 1 or the like. The communication unit 24 is a communication interface for transmitting and receiving information such as the image data with respect to an external apparatus (not shown). The processing unit 25 executes image processing of reducing the original image to prepare the index image or the like, and generally controls the respective components of the image managing apparatus 20.

The image memory 26 is a storage medium for storing the image data of the original image. The database 27 is a storage medium for storing, as management information, attribute information such as Exif data which accompanies the original image. The program memory 28 is a storage medium for storing a program which operates in the image managing apparatus 20. The temporary memory 29 is a buffer memory which temporarily stores data for the display order change processing.

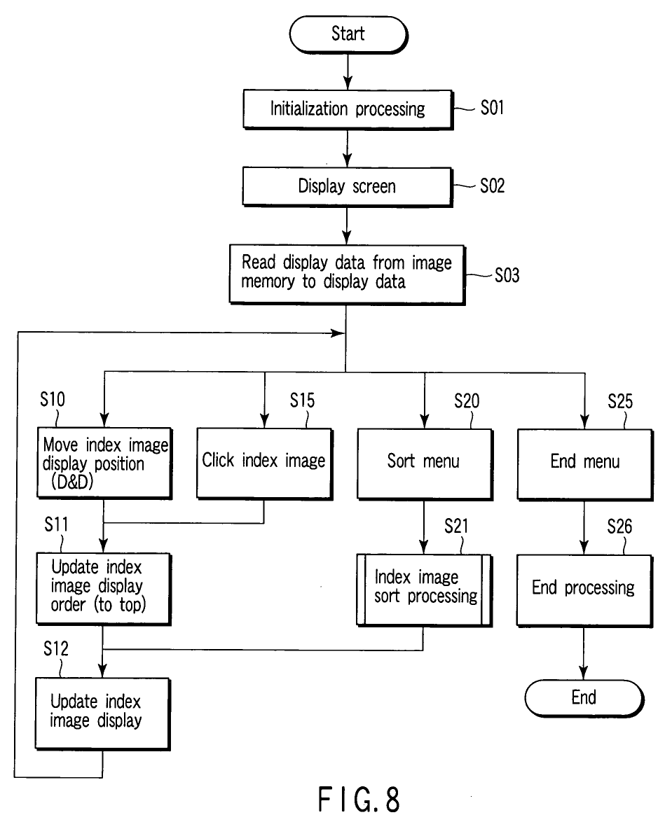

Next, an image display procedure using the image managing apparatus 20 will be described with reference to FIGS. 8 to 10. It is to be noted that image display functions which will below be described are concerned with main functions of the present image display method. Therefore, functions which are not mentioned in the following description but which are described with reference to FIGS. 1 to 7 are included in the functions regarding the present image display method.

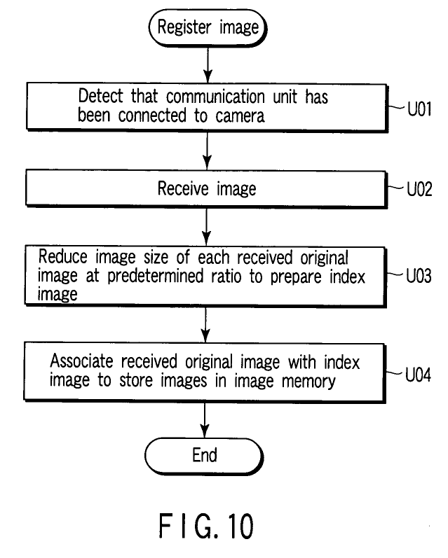

FIG. 10 is a flow chart showing a processing procedure for the image managing apparatus 20 of the present embodiment to acquire the original image as a management object from the external apparatus.

In a step U01, the processing unit 25 detects that an external apparatus (not shown) such as a digital camera is connected to the communication unit 24. When the connection of the external apparatus is detected, an image transmission request command is transmitted to the external apparatus. In a step U02, the processing unit receives an image transmitted from the external apparatus in response to the image transmission command.

In a step U03, the processing unit 25 reduces each received image as the original image at a predetermined ratio to prepare a reduced image for the index. Then, in a step U04, the processing unit stores the original image and the index image in the image memory 26, and registers, in the database 27, management information including the Exif data accompanying the original image, a size of the index image and information for referring to the original image and the index image.

The processing to acquire the image as the management object is ended by the above processing.

It is to be noted that in the step U03, the original image is reduced at a ratio which is proportional to the size of the original image, a ratio of a square or a ½ square, or the like to prepare the reduced image so that the size of the original image is reflected.

In the step S01 of FIG. 8, the user starts the image managing apparatus 20, so that the processing unit 25 initializes an internal table and the like, and in the step S02, it displays the list display screen 1 in the display unit 22. Then, in response to user's operation for displaying the image data, in the step S03, the processing unit reads the corresponding index image from the image memory 26 to display the image in the data display area 3 of the list display screen 1.

Then, the processing unit waits for the next user's operation input.

In a step S10, when the user performs a drag and drop operation to change a display position of the index image displayed in the data display area 3, the processing unit changes the display order so that the index image is displayed in the top in a step S11.

Subsequently, in a step S12, the processing unit updates the display of the index image in accordance with the changed display order. Then, the processing unit waits for the next user's operation input.

In a step S15, when the user clicks one of the index images displayed in the data display area 3 to select the image, the processing unit changes the display order so that the index image is displayed in the top in the step S11.

Subsequently, in the step S12, the processing unit updates the display of the index image in accordance with the changed display order. Then, the processing unit waits for the next user's operation input.

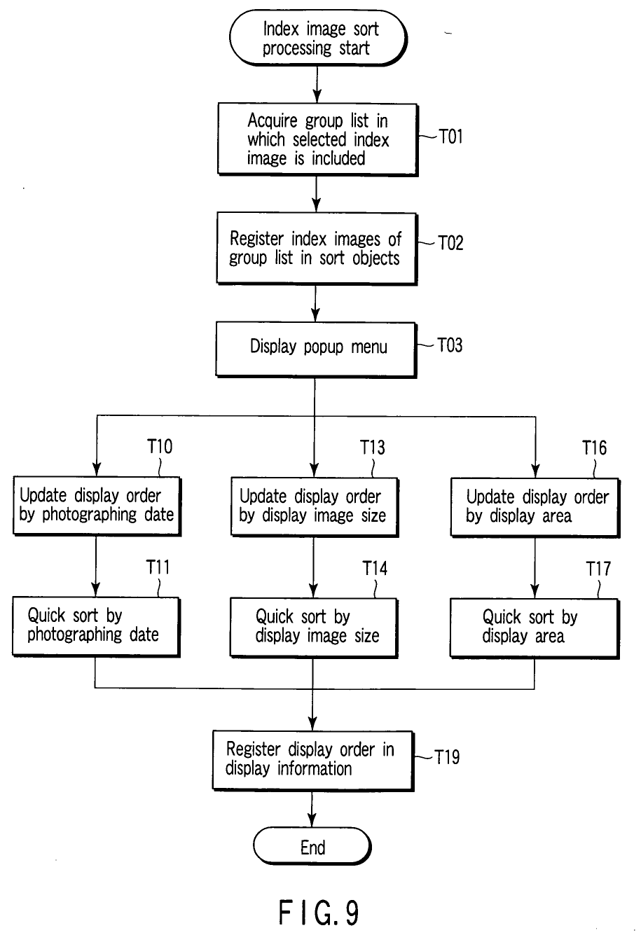

In a step S20, when the user operates the sort button 2a of the tool menu area 2, the processing unit executes index image sort processing (FIG. 9) in a step S21.

In a step T01 of FIG. 9, the processing unit specifies the group in which the selected index image is included, and acquires a list of the index images which belong to the group. In a step T02, the processing unit registers the index images which belong to the group as sort objects in a sort object table (not shown) of the temporary memory 29.

In a step T03, the processing unit displays the sort menu 6, and waits for user's selecting operation.

In a step T10, when the user selects the update of the display orders based on the photographing dates from the sort menu 6, the processing unit sorts the index images as the sort objects based on the photographing dates in a step T11.

Next, in a step T19, the processing unit registers the display orders of the sorted index images in a display information table (not shown) of the temporary memory 29, and ends the index image sort processing.

In a step T13, when the user selects the update of the display orders based on the display image sizes from the sort menu 6, the processing unit sorts the index images as the sort objects based on the display image sizes in a step T14.

Next, in the step T19, the processing unit registers the display orders of the sorted index images in the display information table (not shown) of the temporary memory 29, and then ends the index image sort processing.

In a step T16, when the user selects the update of the display orders based on the display areas from the sort menu 6, the processing unit sorts the index images as the sort objects based on the display image areas in a step T17.

Next, in the step T19, the processing unit registers the display orders of the sorted index images in the display information table (not shown) of the temporary memory 29, and then ends the index image sort processing.

Turning back to FIG. 8, in the step S12, the processing unit updates the display of the index images in accordance with the changed display orders, and waits for the next user's operation input.

In a step S25, when the user operates the end button 2b of the tool menu area 2, the processing unit executes end processing in a step S26 to end the image display processing.

It is to be noted that the functions described above in the embodiment may be constituted using hardware, or realized using software by allowing a computer to read a program in which the functions are described. The respective functions may be constituted by appropriately selecting either the software or the hardware.

Furthermore, the respective functions can be realized by allowing the computer to read a program stored in a storage medium (not shown). Here, the storage medium of the present embodiment may have any recording form, as long as the storage medium can record the program and is a computer-readable storage medium.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An image managing apparatus which includes a display device to display an image and which manages a plurality of original images, the image managing apparatus comprising:
an image display unit which displays in the display device a plurality of images obtained by reducing the original images;
a display order indication unit which indicates conditions to determine display orders of the plurality of images;
an order setting unit which sets the display orders of the plurality of images displayed in the display device or hidden by the displayed images in accordance with the conditions indicated by the display order indication unit; and
a display update unit which updates the display of the display device in accordance with the display orders set by the order setting unit,
wherein the order setting unit sets the display orders of the plurality of images displayed in the display device based on information imparted during photographing of the images or information of display states of the images in the display device in accordance with the conditions indicated by the display order indication unit.

2. The image managing apparatus according to claim 1, wherein the image display unit and the display update unit first display an image having a front display order, and
in a case where an image having a rear display order overlaps the image having the front display order, the image display unit and the display update unit hide an overlapped portion of the image having the front display order by an image having a rear display order.

3. The image managing apparatus according to claim 1, further comprising:
an image group setting unit which sets as one group the images displayed overlapping one another or coming into contact with one another among the plurality of images displayed in the display device; and
an image selection unit which selects the image in the display device,
wherein the order setting unit sets the display orders of the images included in the group to which the image selected by the image selection unit belongs.

4. The image managing apparatus according to claim 3, wherein the display update unit updates the display of all the images displayed in the display device or hidden by the displayed images or the display of the plurality of images which belong to the group in accordance with the orders set by the order setting unit without changing positions of the images in the display device.

5. The image managing apparatus according to claim 1, wherein the information imparted during the photographing is information imparted as an Exif tag including a photographing date and a size of the image to the photographed image, and the information based on the display states is a ratio of a display area or a display size of each image displayed in the display device.

6. The image managing apparatus according to claim 1, wherein the images displayed in the display device are images for indexes obtained by reducing the original images as management objects in accordance with sizes of the original images.

7. An image managing method of an image managing apparatus which includes a display device to display a plurality of images and which manages a plurality of original images, the method comprising:
displaying in the display device the plurality of images obtained by reducing the original images;
indicating conditions on which display orders of the plurality of images are determined;
setting the display orders of the plurality of images displayed in the display device or hidden by the displayed images in accordance with the indicated conditions; and
updating the display of the display device in accordance with the set display orders,
wherein the setting of the display orders of the plurality of images is to set the display orders of the plurality of images displayed in the display device based on information imparted during photographing of the images or information of display states of the images in the display device in accordance with the conditions indicated to determine the display orders of the plurality of images.

8. The image managing method according to claim 7, wherein in the display in the display device and the updated display in the display device, the image having a front display order is first displayed, and
in a case where an image having a rear display order overlaps the image having the front display order, an overlapped portion of the image having the front display order is hidden by the image having the rear display order.

9. The image managing method according to claim 7, further comprising:
setting as one group the images displayed overlapping one another or coming into contact with one another among the plurality of images displayed in the display device; and
selecting the image in the display device,
wherein the setting of the display orders is to set the display orders of the images included in the group to which the selected image belongs.

10. The image managing method according to claim 9, wherein the updating of the display updates the display of all the images displayed in the display device or hidden by the displayed images or the display of the plurality of images which belong to the group in accordance with the orders set by the setting of the display orders without changing positions of the images in the display device.

11. The image managing method according to claim 7, wherein the information imparted during the photographing is information imparted as an Exif tag including a photographing date and a size of the image to the photographed image, and the information based on the display states is a ratio of a display area or a display size of each image displayed in the display device.

12. The image managing method according to claim 7, wherein the images displayed in the display device are images for indexes obtained by reducing the original images as management objects in accordance with sizes of the original images.

13. A storage medium in which a program is stored, the program being executed by an image managing apparatus which includes a display device to display a plurality of images and which manages a plurality of original images, the program executing:
an image display step of displaying in the display device the plurality of images obtained by reducing the original images;
a display order indication step of indicating conditions on which display orders of the plurality of images are determined;
an order setting step of setting the display orders of the plurality of images displayed in the display device or hidden by the displayed images in accordance with the conditions indicated in the display order indication step; and
a display update step of updating the display of the display device in accordance with the display orders set in the order setting step,
wherein the order setting step sets the display orders of the plurality of images displayed in the display device based on information imparted during photographing of the images or information of display states of the images in the display device in accordance with the conditions indicated in the display order indication step.

14. The storage medium according to claim 13, wherein in the image display step and the display update step, an image having a front display order is first displayed, and
in a case where an image having a rear display order overlaps the image having the front display order, an overlapped portion of the image having the front display order is hidden by the image having the rear display order.

15. The storage medium according to claim 13, wherein the program further executes:
an image group setting step of setting as one group the images displayed overlapping one another or coming into contact with one another among the plurality of images displayed in the display device; and
an image selection step of selecting the image in the display device, and
the order setting step sets the display orders of the images included in the group to which the image selected in the image selection step belongs.

16. The storage medium according to claim 15, wherein the display update step updates the display of all the images displayed in the display device or hidden by the displayed images or the display of the plurality of images which belong to the group in accordance with the orders set in the order setting step without changing positions of the images in the display device.

17. The storage medium according to claim 13, wherein the information imparted during the photographing is information imparted as an Exif tag including a photographing date and a size of the image to the photographed image, and the information based on the display states is a ratio of a display area or a display size of each image displayed in the display device.

18. The storage medium according to claim 13, wherein the images displayed in the display device are images for indexes obtained by reducing the original images as management objects in accordance with sizes of the original images.
